(19) United States
(12) Patent Application Publication
(10) Pub. No.: US 2024/0422822 A1
(43) Pub. Date: Dec. 19, 2024

(54) TRANSMISSION OPPORTUNITY SHARING WITH MULTIPLE USERS

(71) Applicant: Samsung Electronics Co., Ltd., Suwon-si (KR)

(72) Inventors: Rubayet Shafin, Frisco, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei City (TW)

(21) Appl. No.: 18/732,509

(22) Filed: Jun. 3, 2024

Related U.S. Application Data
(60) Provisional application No. 63/521,584, filed on Jun. 16, 2023.

(51) Int. Cl. H04W 74/0816; H04W 28/02; H04W 74/08

(52) U.S. Cl. CPC H04W 74/0816; H04W 28/0278; H04W 74/0875

(57) ABSTRACT

A first station (STA) device in a wireless network, the first STA device comprising a memory and a processor coupled to the memory, the processor is configured to obtain a transmission opportunity (TXOP) for transmission of a frame on a link, allocate a portion of the TXOP to a plurality of STAs; transmit a trigger frame to the plurality of STAs indicating allocation of the portion of TXOP; and receive a response frame from at least one STA acknowledging the allocation of the portion of the TXOP.

### CROSS-REFERENCE TO RELATED APPLICATIONS

This application claims the benefit of priority from U.S. Provisional Application No. 63/521,584, entitled “Method and Apparatus for Sharing a Transmit Opportunity (TXOP) With Multiple Users” filed Jun. 16, 2023, which is incorporated herein by reference in its entirety.

### TECHNICAL FIELD

This disclosure relates generally to a wireless communication system, and more particularly to, for example, but not limited to, transmission opportunity (TXOP) sharing procedures in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network. The STA comprises a memory and a processor coupled to the memory. The processor is configured to obtain a transmission opportunity (TXOP) for transmission of a frame on a link. The processor is configured to allocate a portion of the TXOP to a plurality of STAs. The processor is configured to transmit a trigger frame to the plurality of STAs indicating allocation of the portion of TXOP. The processor is configured to receive a response frame from at least one STA acknowledging the allocation of the portion of the TXOP.

In some embodiments, the plurality of STAs comprises at least one access point (AP) and at least one non-AP STA.

In some embodiments, the trigger frame specifies a first time duration on the portion of the TXOP that is allocated to a first STA and a second time duration on the portion of the TXOP that is allocated to a second STA.

In some embodiments, the trigger frame specifies a first subchannel that a first STA in the plurality of STAs is allowed to use and a second subchannel that a second STA in the plurality of STAs is allowed to use.

In some embodiments, the trigger frame specifies a first time duration allocated to a first STA and a first subchannel that the first STA is allowed to use and a second time duration allocated to a second STA and a second subchannel that the second STA is allowed to use.

In some embodiments, an access point (AP) and a non-AP are allocated to a same portion of the TXOP.

In some embodiments, the plurality of STAs include at least one access point (AP) that is allocated to the TXOP on a first channel, a first STA in the plurality of STAs is allocated to the second channel of the TXOP for a time duration and a second STA in the plurality of STAS is allocated to the second channel of the TXOP for a subsequent time duration.

In some embodiments, the processor is configured to allocate different portions of the TXOP to different STAs based on a buffer status of the plurality of STAs.

In some embodiments, the processor is configured to allocate different portions of the TXOP to different STAs in the plurality of STAs based on quality of service (QOS) requirements, traffic priority, or device priority levels of the plurality of STAs.

In some embodiments, the processor is configured to determine that a first STA in the plurality of STAs has latency-sensitive traffic and a second STA in the plurality of STAs has latency tolerant traffic, and allocate more portions of the TXOP to the first STA than the second STA.

One aspect of the present disclosure provides an access point (AP) in a wireless network. The AP comprises a memory and a processor coupled to the memory. The processor is configured to obtain a transmission opportunity (TXOP) for transmission of a frame on a link. The processor is configured to allocate a portion of the TXOP to a plurality stations (STAs). The processor is configured to transmit a trigger frame to the plurality of STAs indicating allocation of the portion of TXOP. The processor is configured to receive a response frame from at least one STA acknowledging the allocation of the portion of the TXOP.

In some embodiments, the plurality of STAs comprises at least one AP and at least one non-AP STA.

In some embodiments, the trigger frame specifies a first time duration on the portion of the TXOP that is allocated to a first STA and a second time duration on the portion of the TXOP that is allocated to a second STA.

In some embodiments, the trigger frame specifies a first subchannel that a first STA in the plurality of STAs is allowed to use and a second subchannel that a second STA in the plurality of STAs is allowed to use.

In some embodiments, the trigger frame specifies a first time duration allocated to a first STA and a first subchannel that the first STA is allowed to use and a second time duration allocated to a second STA and a second subchannel that the second STA is allowed to use.

In some embodiments, an AP and a non-AP are allocated to a same portion of the TXOP.

In some embodiments, the plurality of STAs include at least one AP that is allocated to the TXOP on a first channel, a first STA in the plurality of STAs is allocated to the second channel of the TXOP for a time duration and a second STA in the plurality of STAS is allocated to the second channel of the TXOP for a subsequent time duration.

In some embodiments, the processor is configured to allocate different portions of the TXOP to different STAs based on a buffer status of the plurality of STAs.

In some embodiments, the processor is configured to allocate different portions of the TXOP to different STAs in the plurality of STAs based on quality of service (QOS) requirements, traffic priority, or device priority levels of the plurality of STAs.

In some embodiments, the processor is configured to determine that a first STA in the plurality of STAs has latency-sensitive traffic and a second STA in the plurality of STAs has latency tolerant traffic and allocate more portions of the TXOP to the first STA than the second STA.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates Mode 1 operation of transmission opportunity (TXOP) sharing in accordance with an embodiment.

FIG. 5 illustrates Mode 2 operation for both UL/DL and P2P communication in accordance with an embodiment.

FIG. 6 illustrates allocation of a TXOP to several STAs in accordance with an embodiment.

FIG. 7 illustrates allocation of different portions of a TXOP different STAs in accordance with an embodiment.

FIG. 8 illustrates allocation of different frequency portions of an obtained TXOP to different STAs in accordance with an embodiment.

FIG. 9 illustrates the allocation of different temporal portions of a TXOP to different STAs in accordance with an embodiment.

FIG. 10 illustrates the allocation of different frequency portions of a TXOP to different STAs in accordance with an embodiment.

FIG. 11 illustrates an allocation of different temporal-frequency portions of a TXOP to different STAs in accordance with an embodiment.

FIG. 12 illustrates an allocation of a TXOP to an AP and other non-AP STAs in accordance with an embodiment.

FIG. 13 illustrates an allocation of different temporal portions of a TXOP to an AP and other non-AP STAs in accordance with an embodiment.

FIG. 14 illustrates an allocation of different frequency portions of a TXOP to an AP and other non-AP STAs in accordance with an embodiment.

FIG. 15 illustrates an allocation of different temporal portions of a TXOP to multiple APs and multiple STAs in accordance with an embodiment.

FIG. 16 illustrates an allocation of different frequency portions of a TXOP to one APs and multiple STAs in accordance with an embodiment.

FIG. 17 illustrates an allocation of different time-frequency portions of a TXOP to multiple APs and multiple STAs in accordance with an embodiment.

FIG. 18 illustrates an example frame exchange sequences for allocating TXOP to multiple users using a single trigger frame in accordance with an embodiment.

FIG. 19 illustrates an example frame exchange sequence for allocating different frequency portions of a TXOP to multiple users using a single trigger frame in accordance with an embodiment.

FIG. 20 illustrates a multiuser request-to-send (Mu-RTS) TXOP sharing (TXS) frame format in accordance with an embodiment.

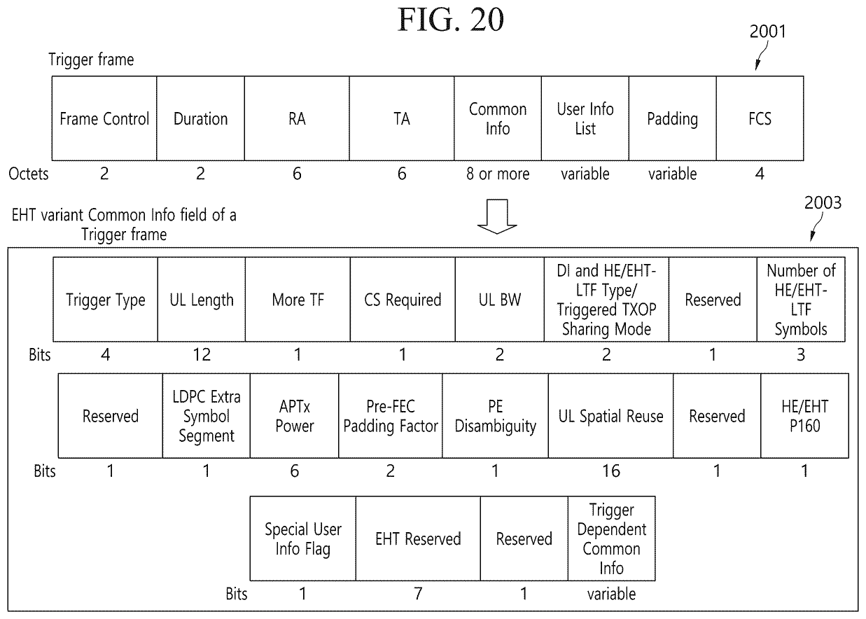

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11bc. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

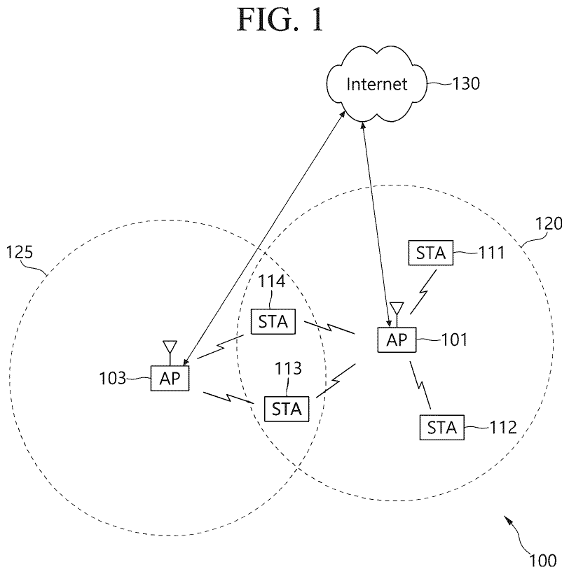

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

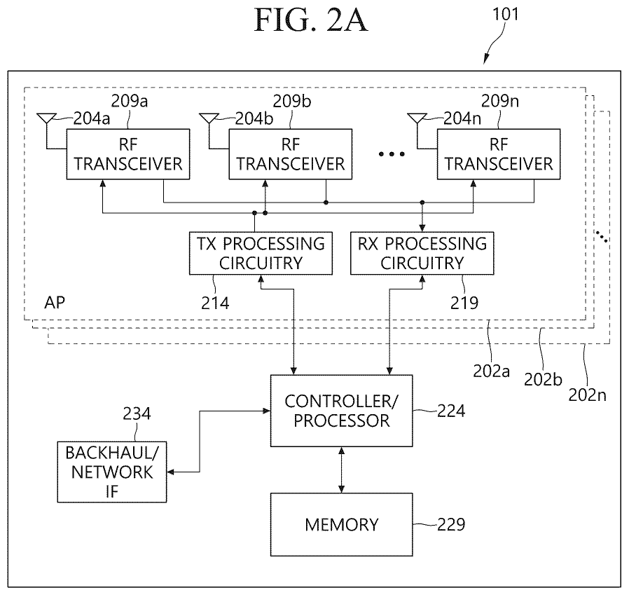

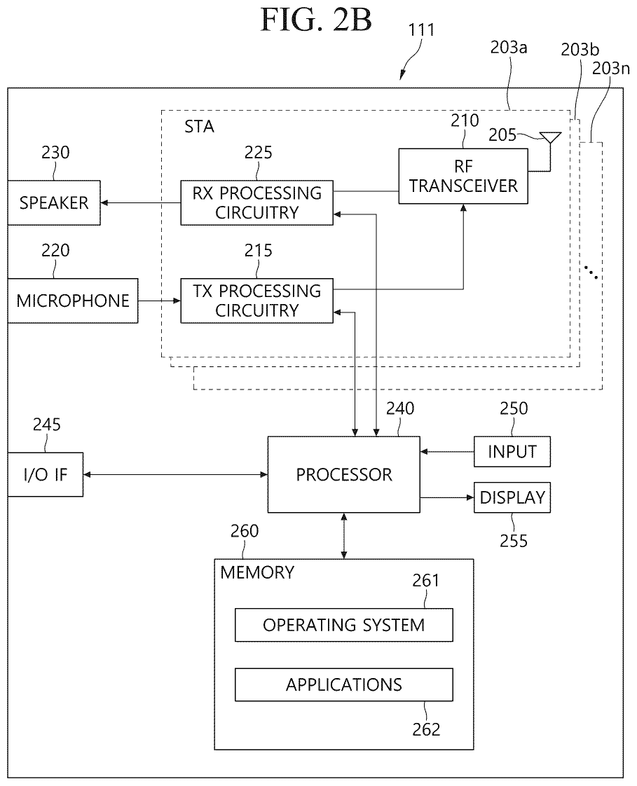

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

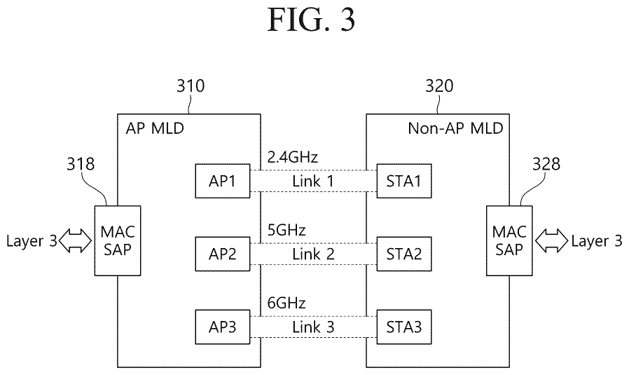

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

Triggered TXOP Sharing (TXS) is a feature in IEEE 802.11be. Using the TXOP sharing procedure, an AP may help an STA to obtain the channel so that the STA can deliver its packets. TXOP sharing procedure may include the following five steps. In step 1, an AP may first obtain the channel, whereby the AP may obtain the TXOP for the wireless medium. In step 2, the AP may decide to allocate a portion of its obtained TXOP to a particular STA, for example STA1, in its BSS. In step 3, the AP may make some indications to STA1 that informs STA1 about the allocated TXOP. In step 4, the STA1 utilizes the allocated TXOP for its uplink or peer-to-peer (P2P) communication. In step 5, the STA1 returns the TXOP to the AP after utilizing its allocated TXOP. The AP may indicate to an STA about the STA's allocated TXOP by using a multi-user request-to-send (MU-RTS) TXS frame, which is a trigger frame introduced in IEEE 802.11bc. Currently, one MU-RTS TXS Trigger frame can allocate TXOP to a single STA only, and not more than one STAs.

There are two TXOP sharing modes, which include Mode 1 that is used only for uplink/downlink (UL/DL) communication and Mode 2 which may be used for both UL/DL and peer to peer (P2P) communication.

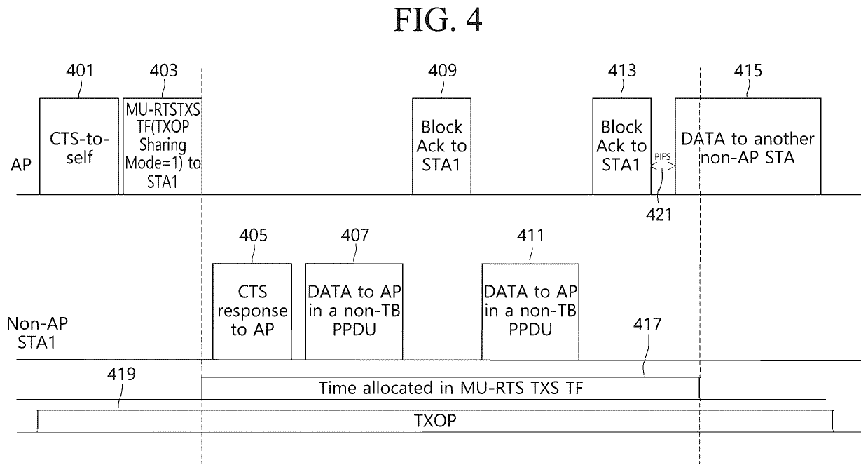

FIG. 4 illustrates Mode 1 operation of TXOP sharing in accordance with an embodiment. In the Mode 1 (UL/DL communication), the AP allocates the TXOP to a STA, illustrated as non-AP STA1, and indicates to the STA1 that the STA1 can use this TXOP 419 only to transmit uplink data packets.

In some embodiments, AP transmits a clear to send (CTS)-to-self frame 401. A CTS-to-self frame is a CTS frame in which the receiver address (RA) field is equal to the transmitter's MAC address. Then, AP transmits a MU-RTS TXS Trigger Frame (TXOP Sharing Mode=1) 403 to STA 1. AP allocates a portion of time 417 of the TXOP 419 to STA1 in the MU-RTS TXS trigger frame 403. Accordingly, during the allocated portion of time 417, STA 1 exchanges frames with AP. For instance, STA1 transmits a CTS response frame 405 to AP. Subsequently, STA 1 transmits data in a non-Trigger Based Physical Layer Protocol Data Unit (non-TB PPDU) 407 to AP. The AP transmits a Block Ack 409 to STA1. STA1 transmits another data in non-TB PPDU 411 to AP and the AP transmits a Block Ack 413 to STA1. Then, after a Point Coordination Function Interframe Space (PIFS) 421, AP transmits data 415 to another non-AP STA.

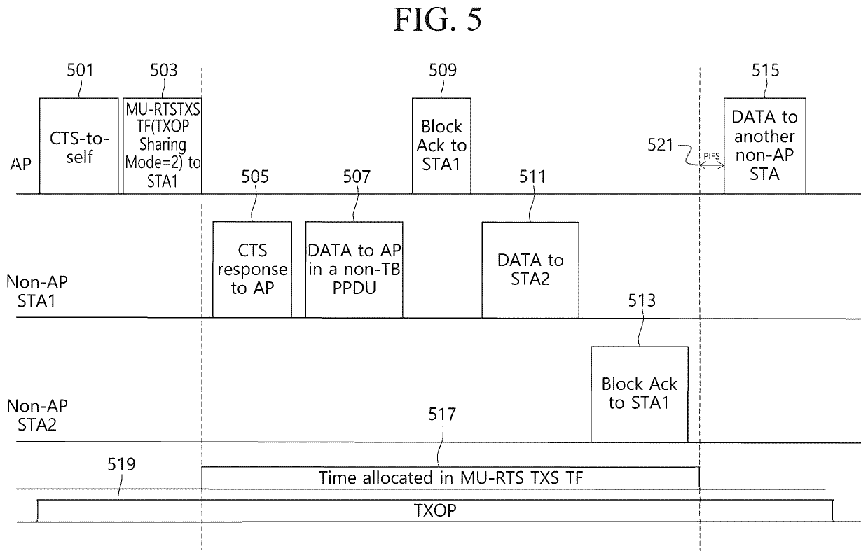

FIG. 5 illustrates Mode 2 operation for both UL/DL and P2P communication in accordance with an embodiment. In Mode 2, the AP allocates a portion of the TXOP to a STA and indicates to the STA that the STA can use the allocated TXOP for both uplink communication and P2P communication. As illustrated in FIG. 5, the STA1 uses the allocated TXOP from the AP for both uplink communication with the AP and P2P communication with STA2.

Referring to FIG. 5, AP transmits a CTS-to-self frame 501. In some embodiments, a CTS-to-self frame may allow an AP to obtain channel access protection, which may provide a lower overhead than a full request-to-send (RTS)/CTS exchange. Accordingly, AP transmits a MU-RTS TXS Trigger Frame (TXOP Sharing Mode=2) 503 to STA 1. During TXOP 519, there is a portion of the TXOP time allocated for STA1, indicated as Time allocated in MU-RTS TXS Trigger Frame 517. During the allocated time, STA1 transmits a CTS response 505 to the AP. STA1 transmits data in a non-TB PPDU 507 to the AP. The AP transmits a Block Ack 509 to the STA1. Subsequently, STA1 transmits data 511 to STA2. STA2 transmits a Block Ack 513 to STA 1. Then, after a PIFS 521, AP transmits data 515 to another non-AP STA.

Accordingly, in the two TXOP sharing modes, only the access point (AP), after winning the contention, can share the won TXOP with a non-AP STA. Currently, TXOP allocation is exclusively allocated to only one user. Accordingly, embodiments in accordance with this disclosure provide for enabling the allocation of a TXOP to multiple STAs using a single trigger frame. Some embodiments of this disclosure provide for assigning a TXOP to multiple users using a single trigger frame. In some embodiments, an AP or a STA, using a single trigger frame, can allocate TXOPs to multiple STAs.

In some embodiments, a first STA (e.g., an AP or a non-AP STA) can indicate to several other STAs that a TXOP can be shared by the several other STAs. In some embodiments, the first STA can send a trigger frame (e.g., an MU-RTS TXS trigger frame) to the several STAs and can indicate the allocated time corresponding to this TXOP.

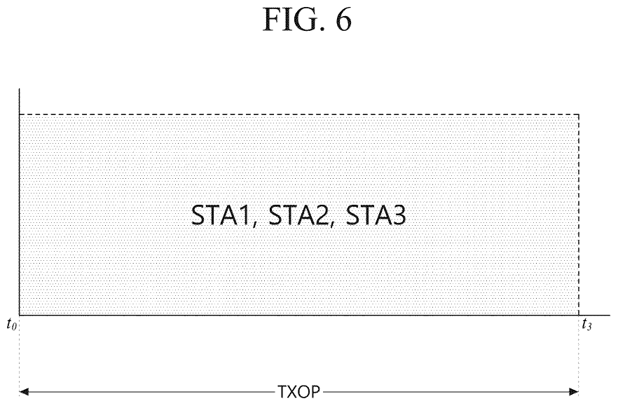

FIG. 6 illustrates allocation of a TXOP to several STAs in accordance with an embodiment. In FIG. 6, a TXOP allocation is shown where the TXOP starts at time to and ends at time t₃. The TXOP is allocated to STA1, STA2, and STA3 from time t₀ to t₃. Accordingly, either STA1, STA2, or STA3 can use the TXOP for its transmission. In some embodiments, the STAs can contend for the channel. In certain embodiments, an AP can allocate priority to the STAs and/or provide other information that can be used in order to determine access to the TXOP amongst the STAs.

In some embodiments, a first STA can allocate different portions of an obtained TXOP to different STAs. The first STA can send a trigger frame (e.g., an MU-RTS TXS trigger frame) to other STAs indicating which of the other STAs is allocated which portion of the TXOP.

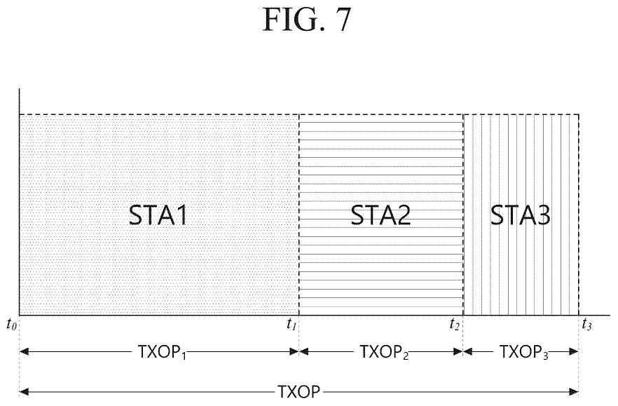

FIG. 7 illustrates allocation of different portions of a TXOP different STAs in accordance with an embodiment. In FIG. 7, a first portion of a TXOP is allocated to STA1 from time t₀ to t₁, a second portion of the TXOP is allocated to STA2 from time t₁ to time t₂, and a third portion of the TXOP is allocated to STA3 from time t₂ to time t₃.

In some embodiments, a first STA can allocate different frequency portions (e.g., subchannels) of an obtained TXOP to different STAs. The first STA can send a trigger frame (e.g., an MU-RTS TXS trigger frame) to other STAs indicating which of the other STAs is allocated which frequency portion of an obtained TXOP.

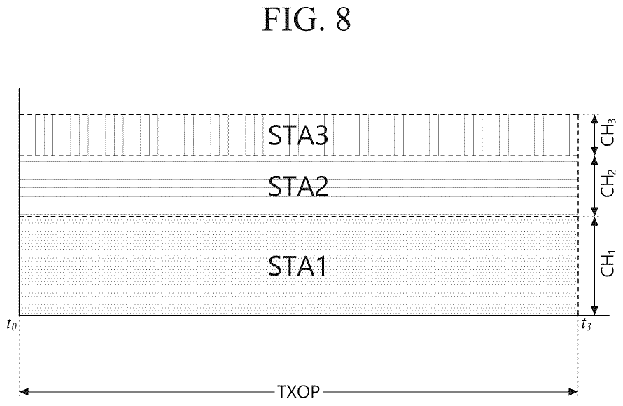

FIG. 8 illustrates allocation of different frequency portions of an obtained TXOP to different STAs in accordance with an embodiment. In FIG. 8, for a TXOP allocation from t₀ to t₃, channel 1 is assigned to STA1, channel 2 is assigned to STA2, and channel 3 is assigned to STA3.

In some embodiments, a first STA can allocate different time-frequency portions of an obtained TXOP to different STAs. The first STA can send a trigger frame (e.g., an MU-RTS TXS trigger frame) to other STAs indicating which of the other STAs is allocated which time-frequency portion of an obtained TXOP. A particular time-frequency portion of a TXOP can be allocated to one or multiple STAs.

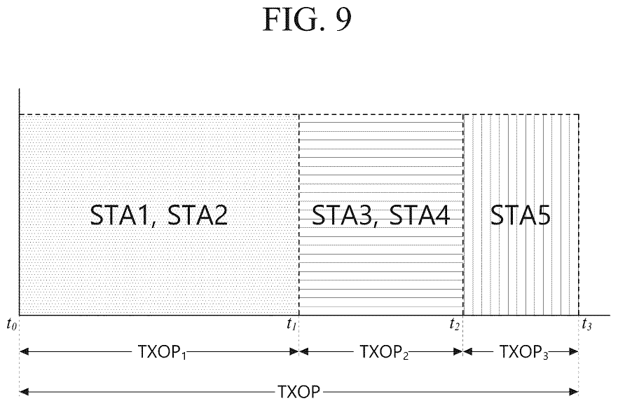

FIG. 9 illustrates the allocation of different temporal portions of a TXOP to different STAs in accordance with an embodiment. As illustrated in FIG. 9, some portions are allocated to multiple STAs. In particular, from time t₀ to t₁, the portion of the TXOP, indicated as TXOP1, is allocated to STA1 and STA2. From time t₁ to t₂, the portion of the TXOP, indicated as TXOP2, is allocated to STA3 and STA4. From time t₂ to t₃, the portion of the TXOP, indicated as TXOP3, is allocated to STA5.

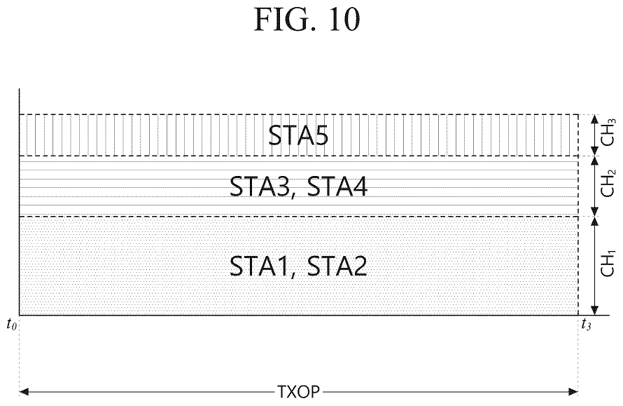

FIG. 10 illustrates the allocation of different frequency portions of a TXOP to different STAs in accordance with an embodiment. In particular, as illustrated, some portions are allocated to multiple STAs. In particular, from time t₀ to t₃, channel 1 is assigned to STA1 and STA2, channel 2 is assigned to STA3 and STA4, and channel 3 is assigned to STA5.

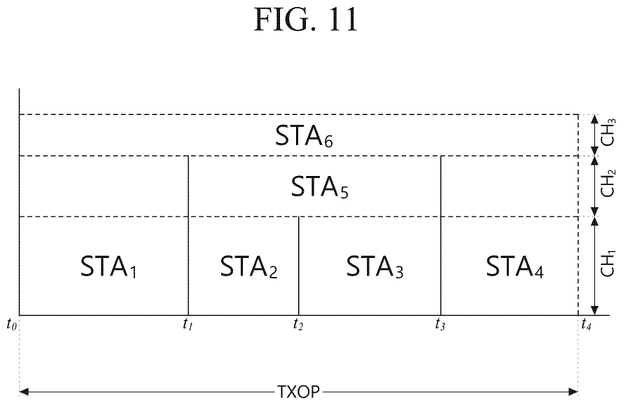

FIG. 11 illustrates an allocation of different temporal-frequency portions of a TXOP to different STAs in accordance with an embodiment. In particular, from time t₀ to t₁, channel 1 is allocated to STA1, from time t₁ to t₂, channel 1 is allocated to STA2, from time t₂ to t₃, channel 1 is allocated to STA3, and from time t₃ to t₄, channel 1 is allocated to STA4. From time t₁ to t₃, channel 2 is allocated to STA5. From time t₀ to t₄, channel 3 is allocated to STA6.

In some embodiments, a TXOP can be allocated to an AP and other non-AP STAs. A first STA can allocate different time-frequency portions of an obtained TXOP to one or more APs and/or to one or more non-AP STAs. The first STA can send a trigger frame (e.g., an MU-RTS TXS trigger frame) to one or more APs and/or one or more STAs indicating which of the other STAs is allocated which time-frequency portion of an obtained TXOP.

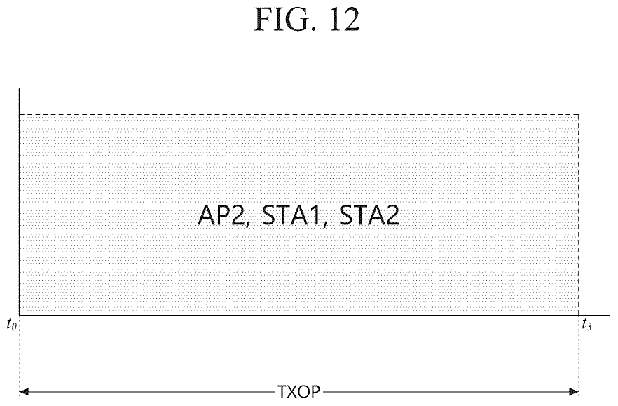

FIG. 12 illustrates an allocation of a TXOP to an AP and other non-AP STAs in accordance with an embodiment. In particular, from time t₀ to t₃, the TXOP is allocated to AP2, STA1 and STA2.

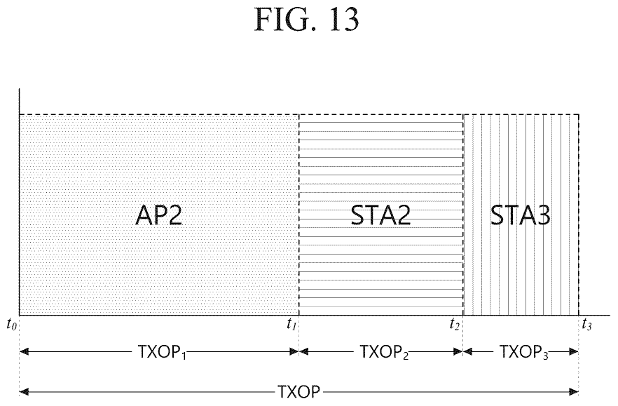

FIG. 13 illustrates an allocation of different temporal portions of a TXOP to an AP and other non-AP STAs in accordance with an embodiment. In particular, from time t₀ to t₁, the portion of the TXOP, indicated as TXOP1, is allocated to AP1. From time t₁ to t₂, the portion of the TXOP, indicated as TXOP2, is allocated to STA2. From time t₂ to t₃, the portion of the TXOP, indicated as TXOP 3, is allocated to STA3.

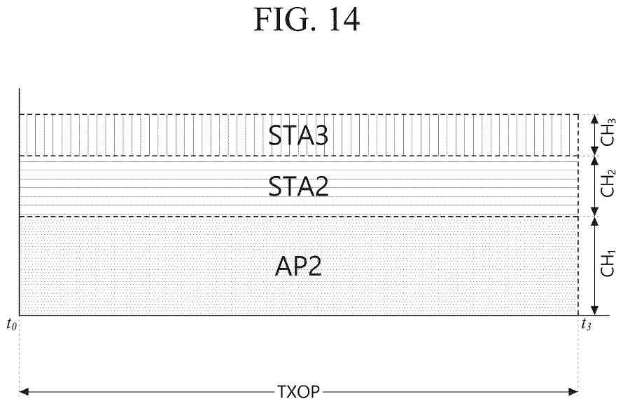

FIG. 14 illustrates an allocation of different frequency portions of a TXOP to an AP and other non-AP STAs in accordance with an embodiment. In particular, from time t₀ to t₃, channel 1 is allocated to AP2, channel 2 is allocated to STA2, and channel 3 is allocated to STA3.

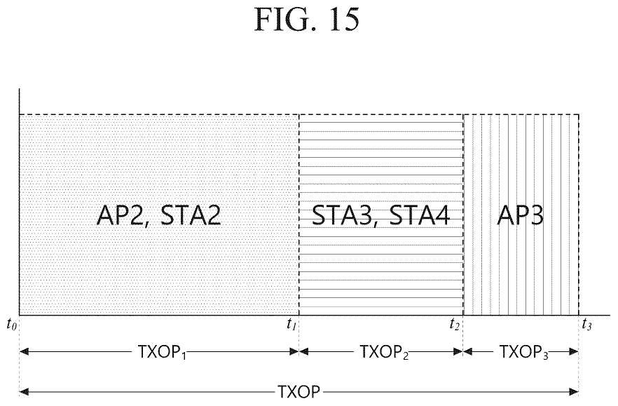

FIG. 15 illustrates an allocation of different temporal portions of a TXOP to multiple APs and multiple STAs in accordance with an embodiment. In particular, from time t₀ to t₁, the portion of the TXOP, indicated as TXOP1 is allocated to AP2 and STA2. From time t₁ to t₂, the portion of the TXOP, indicated as TXOP2 is allocated to STA3 and STA4. From time t₂ to t₃, the portion of the TXOP, indicated as TXOP3 is allocated to AP3.

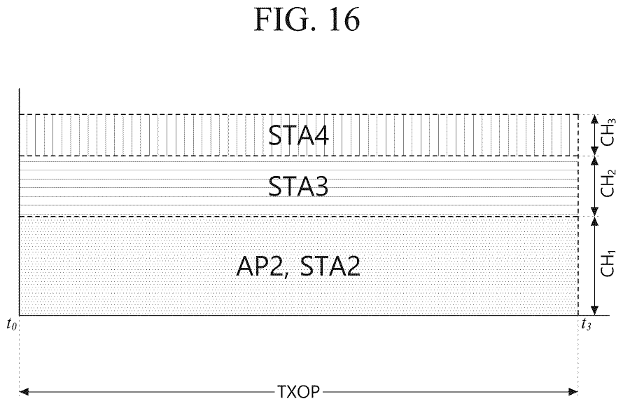

FIG. 16 illustrates an allocation of different frequency portions of a TXOP to one APs and multiple STAs in accordance with an embodiment. In particular, from time t₀ to t₃, channel 1 is allocated to AP2 and STA2, channel 2 is allocated to STA3, and channel 3 is allocated to STA4.

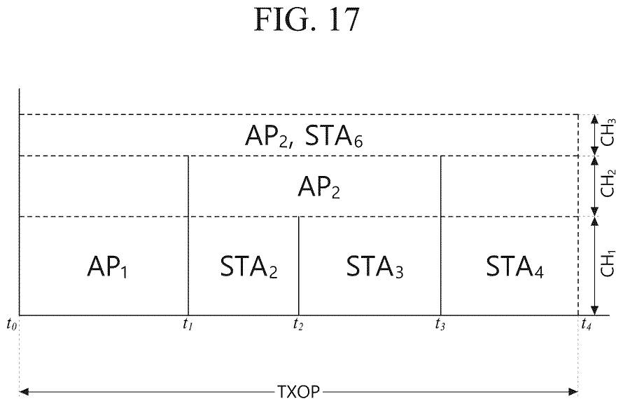

FIG. 17 illustrates an allocation of different time-frequency portions of a TXOP to multiple APs and multiple STAs in accordance with an embodiment. In particular, from time t₀ to t₁, channel 1 is allocated to AP1, from time t₁ to t₂, channel 1 is allocated to STA2, from time t₂ to t₃, channel 1 is allocated to STA3, and from time t₃ to t₄, channel 1 is allocated to STA4. From time t₁ to t₃, channel 2 is allocated to AP2. From time t₀ to t₄, channel 3 is allocated to AP2 and STA6.

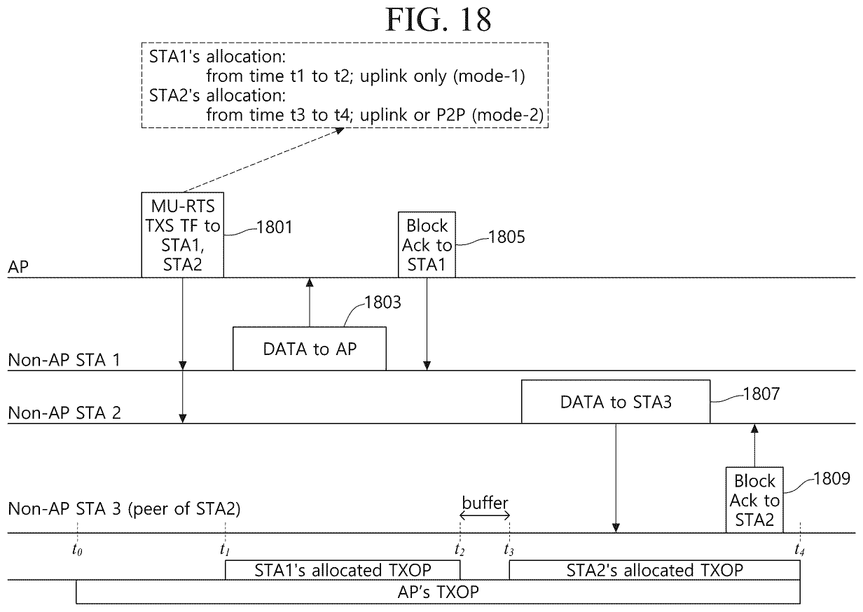

FIG. 18 illustrates an example frame exchange sequences for allocating TXOP to multiple users using a single trigger frame in accordance with an embodiment. In FIG. 18, the AP obtains the TXOP starting from time t₀ to time t₄. In some embodiments, the AP may contend with one or more other APs in order to obtain the TXOP. The AP sends a trigger frame 1801 (e.g., MU-RTS TXS trigger frame) to STA1 and STA2 and indicates in the trigger frame that the AP allocates a first portion of the TXOP (from time t₁ to time t₂) to STA1. The AP also indicates in the trigger frame 1801 that it allocates a second portion (from time t₃ to time t₄) of the TXOP to STA2. The AP can leave some buffer time between the two TXOP allocations to the two users. The AP can also indicate in the trigger frame the mode of transmission (e.g., uplink or P2P) allowed during the allocated TXOP. Accordingly, during the portion of the TXOP allocated to STA1 from time t₁ to time t₂, STA1 transmits data 1803 to AP1 and AP1 transmits a block acknowledgment (ACK) 1805 to STA1. During the portion of the TXOP allocated to STA2 from time t₃ to time t₄, STA2 transmits data 1807 to STA3 and STA3 transmits a block acknowledgment (ACK) 1809 to STA1. STA3 may be a peer of STA2.

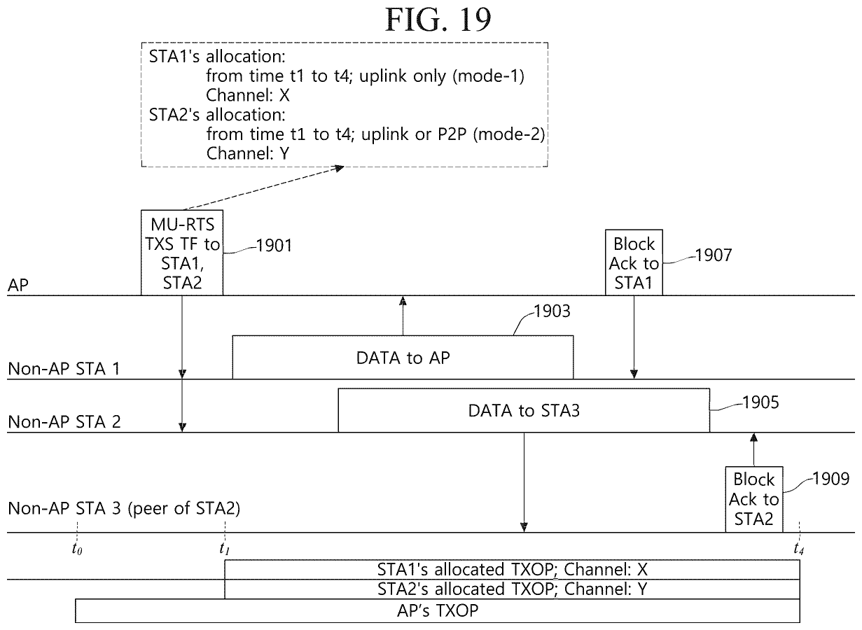

FIG. 19 illustrates an example frame exchange sequence for allocating different frequency portions of a TXOP to multiple users using a single trigger frame in accordance with an embodiment.

In FIG. 19, the AP obtains the TXOP starting from time t₀ to time t₄. The AP sends a trigger frame 1901 (e.g., an MU-RTS TXS trigger frame) to STA1 and STA2 and indicates that the AP allocates a TXOP from time t1 to t4 to both STA1 and STA2. The AP in the trigger frame also indicates that during the TXOP, Channel X is assigned to STA1 and Channel Y is assigned to STA2. The AP can also indicate the mode of transmission (uplink or P2P) allowed during the allocated TXOP. In particular, the AP indicates in the trigger frame 1901 that STA1 is allowed uplink only (Mode-1) and STA2 is allowed uplink or P2P (mode-2). Accordingly, during STA1's allocated TXOP, STA1 transmits data 1903 to AP on channel X and receives a block acknowledgment 1907 from AP. During STA2's allocated TXOP, STA2 transmits data 1905 to STA3 on channel Y and receives a block acknowledgment 1909 from STA3.

In some embodiments, if a first STA (e.g., an AP or non-AP STA) intends to allocate a TXOP to several STAs, the first STA can send a trigger frame (e.g., MU-RTS TXS trigger frame) to those several STAs. In the MU-RTS TXS trigger frame, there can multiple User Info fields corresponding to those multiple user STAs. Each User Info field can include TXOP allocation-related information for each of those multiple user STAs. A STA that receives the MU-RTS TXS Trigger frame can know the portion of the TXOP it is allocated from the User Info field corresponding to that User Info field (e.g., matching the AID value of the User Info field with the STA's AID).

In some embodiments, a first STA (e.g., an AP or a non-AP STA) can assign different portions of an obtained TXOP to different user STAs based on a buffer status corresponding to those user STAs. For example, the first STA can receive buffer status reports (BSR) from a second STA and from a third STA. If the BSRs received from the second STA and the third STA indicate that the second STA has more packets in its queue than the third STA, then the first STA can allocate more portions of the TXOP to the second STA than to the third STA.

In some embodiments, a first STA (e.g., an AP or a non-AP STA) can assign different portions of an obtained TXOP to different user STAs based on the QoS requirement or traffic priority or device priority levels corresponding to those STAs. For example, if a second STA has latency-sensitive traffic (e.g., the second STA can be an R-TWT scheduled STA) and a third STA has latency-tolerant traffic, then the first STA can allocate more portions of TXOP to the second STA than to the third STA. As another example, if a second STA has higher device priority (e.g. the second STA is an EPCS-enabled STA) than the third STA, then the first STA can allocate more portions of TXOP to the second STA than to the third STA.

FIG. 13 illustrates an MU-RTS TXS frame in accordance with an embodiment. In particular, FIG. 13 illustrates an MU-RTS TXS trigger frame 1301 and an EHT variant Common Info field 1303 of the trigger frame. The MU-RTS TXS frame can include one or more fields, including, but not limited to, a frame control field, a duration field, a receiver address (RA) field, a transmitter address (TA) field, a Common Info field, a User Info List field, a Padding field, and a frame check sequence (FCS) field.

The Frame control field can include a value to indicate the type of frame. The Duration field may be set to the estimated time, in microseconds, required to transmit the pending frame(s). The Receiver Address (RA) field may include the address of the receiver of frame. The Transmitter Address (TA) field may include the address of the transmitter of the frame. The Common Info Field may indicate the MU-RTS TXS Mode and include one or more subfields, as described below. The User Info List may indicate a value of the bandwidth (BW) associated with the MU-RTS frame (and/or BW associated with the PPDU carrying the MU-RTS frame—for example, but not limited to, 320 MHz, 160+160 MHz, 240 MHz, 160+80 MHZ). The Padding field may be used for additional padding to compensate for different lengths of different MU-RTS frames. The FCS field is a frame check sequence for error-detection.

The EHT variant Common Info field 1303 of the trigger frame 1301 may include a Trigger Type field, a UL length field, a More Trigger Frame (TF) field, a Carrier Sense (CS) required field, an Up Link Bandwidth (UL BW) field, A DI and HE/E HT-LTF Type/Triggered TXOP Sharing Mode field, a Reserved Field, a Number of HE/EHT-LTF Symbols field, a Reserved field, a Low-Density Parity Check (LDPC) Extra Symbol Segment field, a AP transmitter (TX) power field, a Pre-FEC Padding Factor field, a PE Disambiguity field, a UL Spatial Resue field, a Reserved field, an HE/EHT P160 filed, a Special User Info Flag field, a EHT Reserved field, a Reserved field, and a Trigger Dependent Common Info field.

The trigger type field may indicate a MU-RTS trigger frame. The UL Length field may signal a length of the expected response frame. The More TF field may indicate whether or not a subsequent trigger frame is scheduled for transmission. The CS Required field is set to 1 to indicate that the STAs identified in the User Info fields are required to use Energy Detect (ED) to sense the medium and to consider the medium state and the Network Allocation Vector (NAV) in determining whether or not to respond. The UL BW field (Up Link Bandwidth) indicates the bandwidth of the transmission. The GI and HE/EHT LTF Type/Triggered TXOP Sharing Mode field indicates the guard interval and long training field (GI and HE/EHT-LTF) type of the HE or EHT TB PPDU response, and the field may switch meaning between GI and HE/EHT-LTF type and triggered TXOP sharing mode fields based on the trigger type.

The Reserved field is reserved. The Number of HE/EHT LTF Symbols field indicates the number of HE-LTF symbols present in the HE TB PPDU or EHT-LTF symbols present in the EHT TB PPDU, respectively. The Reserved field is reserved. The LDPC Extra Symbol Segment field indicates the status of the LDPC extra symbol segment. The AP TX Power field provides the Tx Power used to transmit the frame. The Pre-FEC Padding Factor field indicates the pre-FEC padding factor. The PE Disambiguity field indicates the PE disambiguity. The UL Spatial Reuse field carries the values to be included in the Spatial Reuse fields in the HE-SIG-A field of the solicited HE TB PPDUs. The Reserved field is reserved. The HE/EHT P160 field may indicate whether the solicited TB PPDU in the primary 160 MHz is an EHT TB PPDU or an HE TB PPDU. The Special User Info Flag field may indicate that a Special User Info field is included in the Trigger frame that contains the EHT variant Common Info field. The EHT Reserved field is reserved. The Reserved field is reserved. The Trigger Dependent Common Info field is optionally present based on the value of the Trigger Type field.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory;
a processor coupled to the memory, the processor configured to:
obtain a transmission opportunity (TXOP) for transmission of a frame on a link;
allocate a portion of the TXOP to a plurality of STAs;
transmit a trigger frame to the plurality of STAs indicating allocation of the portion of TXOP; and
receive a response frame from at least one STA acknowledging the allocation of the portion of the TXOP.

2. The STA of claim 1, wherein the plurality of STAs comprises at least one access point (AP) and at least one non-AP STA.

3. The STA of claim 1, wherein the trigger frame specifies a first time duration on the portion of the TXOP that is allocated to a first STA and a second time duration on the portion of the TXOP that is allocated to a second STA.

4. The STA of claim 1, wherein the trigger frame specifies a first subchannel that a first STA in the plurality of STAs is allowed to use and a second subchannel that a second STA in the plurality of STAs is allowed to use.

5. The STA of claim 1, wherein the trigger frame specifies a first time duration allocated to a first STA and a first subchannel that the first STA is allowed to use and a second time duration allocated to a second STA and a second subchannel that the second STA is allowed to use.

6. The STA of claim 1, wherein an access point (AP) and a non-AP are allocated to a same portion of the TXOP.

7. The STA of claim 1, wherein the plurality of STAs include at least one access point (AP) that is allocated to the TXOP on a first channel, a first STA in the plurality of STAs is allocated to the second channel of the TXOP for a time duration and a second STA in the plurality of STAS is allocated to the second channel of the TXOP for a subsequent time duration.

8. The STA of claim 1, wherein the processor is configured to allocate different portions of the TXOP to different STAs based on a buffer status of the plurality of STAs.

9. The STA of claim 1, wherein the processor is configured to allocate different portions of the TXOP to different STAs in the plurality of STAs based on quality of service (QOS) requirements, traffic priority, or device priority levels of the plurality of STAs.

10. The STA of claim 9, wherein the processor is configured to:
determine that a first STA in the plurality of STAs has latency-sensitive traffic and a second STA in the plurality of STAs has latency tolerant traffic; and
allocate more portions of the TXOP to the first STA than the second STA.

11. An access point (AP) in a wireless network, the AP comprising:
a memory;
a processor coupled to the memory, the processor configured to:
obtain a transmission opportunity (TXOP) for transmission of a frame on a link;
allocate a portion of the TXOP to a plurality stations (STAs);
transmit a trigger frame to the plurality of STAs indicating allocation of the portion of TXOP; and
receive a response frame from at least one STA acknowledging the allocation of the portion of the TXOP.

12. The AP claim 11, wherein the plurality of STAs comprises at least one AP and at least one non-AP STA.

13. The AP of claim 11, wherein the trigger frame specifies a first time duration on the portion of the TXOP that is allocated to a first STA and a second time duration on the portion of the TXOP that is allocated to a second STA.

14. The AP of claim 11, wherein the trigger frame specifies a first subchannel that a first STA in the plurality of STAs is allowed to use and a second subchannel that a second STA in the plurality of STAs is allowed to use.

15. The AP of claim 11, wherein the trigger frame specifies a first time duration allocated to a first STA and a first subchannel that the first STA is allowed to use and a second time duration allocated to a second STA and a second subchannel that the second STA is allowed to use.

16. The AP of claim 11, wherein an AP and a non-AP are allocated to a same portion of the TXOP.

17. The AP of claim 11, wherein the plurality of STAs include at least one AP that is allocated to the TXOP on a first channel, a first STA in the plurality of STAs is allocated to the second channel of the TXOP for a time duration and a second STA in the plurality of STAS is allocated to the second channel of the TXOP for a subsequent time duration.

18. The AP of claim 11, wherein the processor is configured to allocate different portions of the TXOP to different STAs based on a buffer status of the plurality of STAs.

19. The AP of claim 11, wherein the processor is configured to allocate different portions of the TXOP to different STAs in the plurality of STAs based on quality of service (QOS) requirements, traffic priority, or device priority levels of the plurality of STAs.

20. The AP of claim 19, wherein the processor is configured to:
determine that a first STA in the plurality of STAs has latency-sensitive traffic and a second STA in the plurality of STAs has latency tolerant traffic; and
allocate more portions of the TXOP to the first STA than the second STA.
